(19) United States
(12) Patent Application Publication
(10) Pub. No.: US 2025/0066227 A1
(43) Pub. Date: Feb. 27, 2025

(54) ENERGY MANAGEMENT STRATEGY AND RECIRCULATION-BASED ARCHITECTURE DESIGNS FOR ELECTRODIALYSIS SYSTEM OPERATION

(71) Applicant: Massachusetts Institute of Technology, Cambridge, MA (US)

(72) Inventors: Jimmy T. Tran, Somerville, MA (US); Melissa Brei, Cambridge, MA (US); Jonathan Bessette, Cambridge, MA (US); Shane Pratt, Cambridge, MA (US); Jeffrey Costello, Cambridge, MA (US); Amos Greene Winter, V, Cambridge, MA (US)

(21) Appl. No.: 18/750,891

(22) Filed: Jun. 21, 2024

Related U.S. Application Data
(60) Provisional application No. 63/533,814, filed on Aug. 21, 2023.

(51) Int. Cl. C02F 1/469

(52) U.S. Cl. CPC C02F 1/4693; C02F 2201/005; C02F 2201/4611; C02F 2201/46115

(57) ABSTRACT

Novel design frameworks for designing electrodialysis (ED) desalination systems for purifying brackish water are provided herein. The design frameworks of the present embodiments include one or more energy management strategies, as well as recirculation-based system architectures. The design frameworks can be independent of each other, or can be used together. In some embodiments, the energy management strategy can include determining a capacity of a battery in communication with an (ED) system and imposing a charge power limit onto the battery to limit the charging rate of the ED system. The energy management strategy can be used in combination with the recirculation-based system architectures to improve efficiency of purification performed by these ED systems. These architectures can include hybrid architectures that operate in continuous flow, but provide a recirculation stream to mix the feed to achieve a desired salinity of the product stream.

### CROSS REFERENCE TO RELATED APPLICATION

The present disclosure claims priority to and the benefit of U.S. Provisional Application No. 63/533,814, entitled “Energy Management Strategy and Recirculation-Based Architecture Design for Electrodialysis System Operation,” filed on Aug. 21, 2023, the content of which is incorporated by reference herein in its entirety.

### GOVERNMENT RIGHTS

This invention was made with government support under R22AC00183 awarded by The Department of The Interior. The government has certain rights in the invention.

### FIELD

The present disclosure relates to novel design frameworks for designing electrodialysis (ED) desalination systems for purifying water, and more particularly relates to energy management strategies and recirculation-based system architectures that achieve optimal efficiency and recovery ratios.

### BACKGROUND

Water scarcity is becoming a growing concern globally, with approximately four (4) billion people experiencing water scarcity for at least one (1) month every year. Water scarcity especially affects resource-constrained communities in arid regions like communities in the Middle East and North Africa (MENA), Native American Reservations in the US-Southwest, and India, where access to clean water is challenging if a reliable water source is not nearby. Additionally, many of these communities live near slightly saline (e.g., approximately in the range of about 1000 ppm to about 3000 ppm) water sources, both above and below ground, which can make water desalination a viable solution to increase clean water access in these regions. Some of these communities also lack reliable access to electricity, introducing a need for off-grid solutions. Further still, when looking at the regions in the world with the highest water stress, there is a noticeable overlap with high solar irradiance regions and these regions' proximity to slightly saline water sources

Photovoltaic electrodialysis reversal (PV-EDR) systems have been shown to affordably desalinate water for resource-constrained communities, like in India. Previous works have shown that when compared to reverse osmosis (RO), electrodialysis reversal (EDR) can operate off-grid more cost-effectively and at a higher water recovery ratio (ratio of clean product water to feed water) for small village scale production volumes. EDR is also more energy efficient than RO when desalinating water less than 4000 ppm. However, these EDR systems suffer from shortcomings. For example, existing systems suffer from poor energy resource allocation. In conventional systems, the energy management (EM) strategy can include time-variant operation for photovoltaic-powered ED systems (PV-ED) by adjusting the flow rate and voltage in the system to match the available solar power generated throughout the day. When more power is available, time-variant operation increases the flow rate and voltage of the system, increasing the production rate of the system. This reduces, however, the salt removal rate in the system and increases pressure losses in the system. As a result, the ED systems generally run less efficiently at a higher specific energy consumption (SEC), or energy consumed per unit of water produced (kWh/m³). Incorporating batteries into off-grid ED system designs decrease the SEC of the system by storing energy when more power is available. When less power is available, the battery can discharge power to run the ED system at its most efficient operating point. However, batteries add a significant cost to the ED system.

Accordingly, there is a need for systems and methods for cost-effective solutions for water desalination procedures that increase energy efficiency and/or recovery ratios.

### SUMMARY

The present application is directed to a new set of design frameworks for designing electrodialysis (ED) desalination systems for purifying brackish water. For example, the ED system of the present embodiments can be an off-grid photovoltaic desalination system, or a system that is powered by some other variable power source, that balances water desalination with energy efficiency while also reducing the overall cost of the system. The ED system can incorporate one or more energy management strategies and/or a recirculation-based system architecture to achieve optimal energy efficiency in combination with high recovery ratios. The energy management strategies can include strategies that prioritize filling the battery, strategies that set a time threshold for battery charging, and/or strategies that use weather data to predict peak solar irradiance to achieve optimal efficiency and/or recovery ratios. In some embodiments, the energy management strategy can include determining a capacity of a battery in communication with an (ED) system and imposing a charge power limit onto the battery to limit the charging rate of the ED system. In some embodiments, the energy management strategy can be used in combination with the recirculation-based system architectures disclosed herein to improve efficiency of purification performed by these ED systems. These architectures can include, for example, hybrid architectures that operate in continuous flow, but provide a recirculation stream to mix the feed to achieve a desired salinity of the product stream.

With the cost savings and energetic efficiency of incorporating both the EM strategies and hybrid architectures, it could be implemented in a wide range of community- or municipality-scale water desalination facilities for communities that face water scarcity around the world.

One exemplary embodiment of a method of energy management for electrodialysis desalination includes determining a capacity of a battery in communication with an electrodialysis (ED) system. Once determined a charge power limit is imposed onto the battery and the battery is charged using an available solar power until the battery reaches its charge power limit. The charging rate of the ED system is limited such that the ED system operates at a lower power operating point than the capacity of the battery. The battery is charged to approximately maintain the charge power limit while performing desalination with the remaining available solar power until the battery is fully charged. Capacity of the battery is determined such that energy from the battery is able to be used to perform desalination.

The method can further include using the available solar power for performing desalination after the battery is fully charged. The available solar power for performing desalination can substantially increase after the battery reaches its charge power limit.

The method can further include discharging the battery to perform desalination. Discharging the battery can occur when the available solar power is insufficient to perform desalination. In some embodiments, charging the battery and performing desalination can occur substantially simultaneously prior to the battery reaching its charge power limit. Alternatively, charging the battery can occur before starting to perform desalination.

In some embodiments, a time threshold at which the battery is configured to begin charging can be applied. The time threshold can be set to a same time as a time threshold of a previous day. In some embodiments, the time threshold can be set to a time immediately before a peak solar irradiance.

The method can further include predicting the peak solar irradiance by measuring weather data. In some embodiments, the method can further include predicting the available solar power to determine time taken to charge the battery.

One exemplary embodiment of a system architecture for electrodialysis desalination includes one or more pumps in fluid communication with an electrodialysis (ED) stack, a feed flowing a fluid to the ED stack, a controller in communication with the one or more pumps and the ED stack, and one or more valves. The ED stack has an inlet for receiving one or more feed streams and an outlet for receiving one or more outlet streams. The feed flows the fluid to the ED stack via the one or more pumps. The controller is configured to operate under time-variant control to adjust one or more of a flow rate or a voltage to the ED stack to use power based on availability of the power. The one or more valves are disposed downstream of the ED stack to receive the one or more outlet streams.

An amount of fluid in the one or more outlet streams recirculated to the one or more pumps can be based on at least one of a target concentration or a desired recovery rate of a product stream of the one or more outlet streams. The amount of fluid in the one or more streams recirculated is calculated, using the controller, by taking the difference between an outlet concentration of the stack and a target concentration. The recirculated outlet stream of the one or more outlet streams can mix with the feed stream to lower the total concentration of the fluid at the inlet.

The system can include one or more check valves configured to direct the recirculated outlet stream of the one or more outlet streams to the one or more pumps. The one or more valves can include a modulating control valve. One or more positive displacement pumps can be disposed along the one or more outlet streams to control a pressure of the recirculated stream of the one or more outlet streams. The controller can be in communication with a battery that provides power to the ED stack. In some embodiments, the controller can be configured to determine a capacity of the battery, impose a charge power limit onto the battery to limit the charging rate thereof such that the ED stack operates at a lower power operating point than the capacity of the battery, charge the battery using available solar power until the battery hits its charge power limit, and charge the battery at the charge power limit while performing desalination with the remaining available solar power until the battery is fully charged. In some embodiments, the controller can be configured to perform any of the methods of the exemplary method discussed above.

### BRIEF DESCRIPTION OF THE DRAWINGS

This disclosure will be more fully understood from the following detailed description taken in conjunction with the accompanying drawings, in which:

FIG. 1 is a graphic illustration of reshaping of a solar power profile using a Morning Fill energy management strategy by storing energy in the battery at different parts in the day;

FIG. 2 is a graphic illustration of reshaping of a solar power profile using an Afternoon Fill energy management strategy by storing energy in the battery at different parts in the day;

FIG. 3 is a graphic illustration of reshaping of a solar power profile using a Charge Limit energy management strategy by storing energy in the battery at different parts in the day;

FIG. 4 is a graphic illustration of reshaping of a solar power profile using a Top Fill energy management strategy by storing energy in the battery at different parts in the day;

FIG. 5 is a schematic illustration of one embodiment of a hybrid architecture in an electrodialysis (ED) system of the present embodiments;

FIG. 6 is a schematic illustration of one embodiment of a controller used to regulate the recirculated flow in the hybrid architecture of FIG. 5;

FIG. 7A is a schematic illustration of another embodiment of a hybrid architecture in an ED system with applicability at least to direct-drive desalination and energy management control;

FIG. 7B is a schematic illustration of still another embodiment of a hybrid architecture in an ED system with applicability at least to direct-drive desalination and energy management control;

FIG. 7C is a schematic illustration of another embodiment of a hybrid architecture in an ED system with applicability at least to direct-drive desalination and energy management control; and

FIG. 7D is a schematic illustration of an embodiment of a feed and bleed hybrid architecture in an ED system with applicability at least to direct-drive desalination and energy management control;

FIG. 8A is a schematic illustration of an adaptation of direct-drive desalination to the feed and bleed system of FIG. 7D with solenoid valves associated with the product stream;

FIG. 8B is a schematic illustration of an adaptation of direct-drive desalination to the feed and bleed system of FIG. 7D with solenoid valves associated with the recovery rate;

FIG. 9A is a schematic illustration of an adaptation of direct-drive desalination to the feed and bleed system of FIG. 7D with proportional control valves associated with the product stream;

FIG. 9B is a schematic illustration of an adaptation of direct-drive desalination to the feed and bleed system of FIG. 7D with proportional control valves associated with the recovery rate; and

FIG. 10 is a table summarizing charging and desalination conditions for each desalination strategy of the present embodiments.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art for components and/or processes of the systems, methods, and compositions disclosed herein and the like may be used interchangeably herein. For example, the terms “direct-drive control scheme,” “direct-drive,” and “direct-drive desalination” can be used interchangeably to refer to hybrid architectures for implementing direct-drive desalination strategies of the present embodiments. Further still, the hybrid architectures, and/or aspects thereof, to which the present disclosure refers and discusses may be referred to by those skilled in the art as “feed and bleed” and/or “recirculation-based” architectures. Such architectures may contain a recirculation loop on a diluate (product) stream, as discussed in detail below. Moreover, the terms “waste” and “brine” can be used interchangeably to refer to the non-product stream that flows out of the electrodialysis stack. A person skilled in the art, in view of the claims, present disclosure, and knowledge of the skilled person, will understand such terms are merely examples of such systems, methods, and/or compositions are possible.

The present disclosure provides a plurality of novel design frameworks for designing electrodialysis (ED) desalination systems for purifying brackish water. The design frameworks of the present embodiments can be broken up into energy management strategies and recirculation-based system architectures. The energy management strategies can be used in combination with the recirculation-based system architectures disclosed herein to improve efficiency of purification performed by these ED systems.

### Energy Management Strategies

The energy management (EM) strategies can dictate when power can be used and how much power can be used for direct desalination versus stored in a battery for off-grid ED systems. To maximize the energetic efficiency of the ED system, the EM strategies can attempt to operate the ED system as close as possible to its most efficient operating point, while storing energy in the battery when more power is available. The present disclosure provides at least four novel EM strategies that can maximize the efficiency of the system, thereby improving and/or maximizing the water production of the system. The EM strategies disclosed herein can be used one at a time or in combination with other energy management strategies, including those disclosed herein, to improve efficiency and/or recovery of desalination of the ED system.

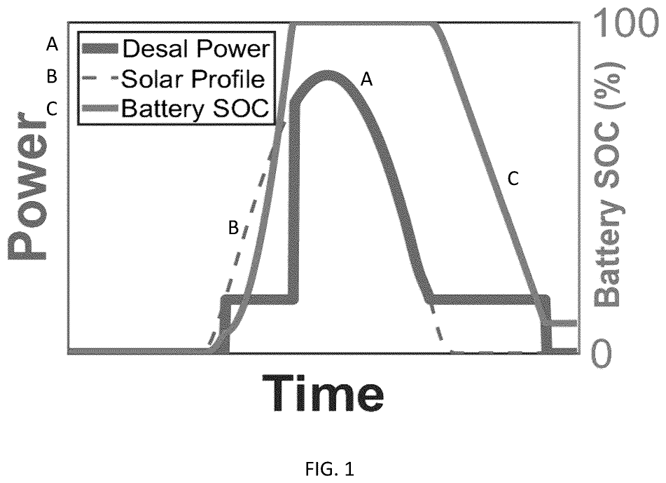

FIG. 1 illustrates an example embodiment of an EM strategy that can maximize battery usage by prioritizing filling the battery. This strategy, referred to as the “Morning Fill” strategy, can fill the battery before anything is filled, sometimes even at the cost of reduced water production efficiency. As shown, the Morning Fill strategy can reshape the solar power profile (curve B) by storing energy in a battery (or batteries) of the ED system throughout various parts of the day. Therefore, the Morning Fill strategy can run the ED system at its most efficient operating point while all leftover solar power can be used to charge the battery, with a state of charge (SOC) of the battery shown in curve C. Once the battery is fully charged, all available solar power (curve A) can be used for desalination of the water, with a spike in desalination power (curve A) seen when curve C reaches 100%. For the purposes of this disclosure, a spike in desalination can refer to a sudden increase in desalination power by at least about 10% and/or about at least 15%.

This EM strategy can allow for inefficient water production as it may cause the ED system to desalinate at peak solar irradiance hours, e.g., in the event that the battery becomes fully charged during the middle of the day, such as at about 12 PM, for example. However, this strategy can capitalize on an initial capital investment made on the battery by ensuring that the battery is fully charged and discharged each day, as shown by the steep decline in curve C in FIG. 1, which can occur when an amount of solar irradiance drops in the afternoon, for example.

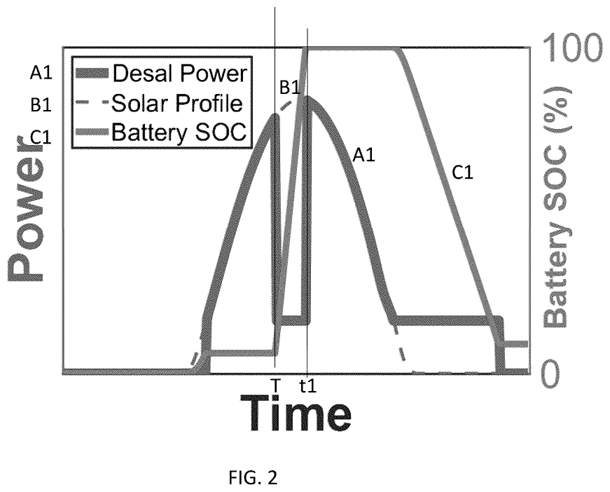

FIG. 2 illustrates another example embodiment of an EM strategy that can improve water production efficiency, including when compared to Morning Fill in at least some instances, by applying a time threshold to begin charging the battery. This strategy, referred to as the “Afternoon Fill” strategy, can set a time threshold T every day at which the battery of the ED system can begin charging. The time threshold T can be set at the same time each day, e.g., 11 AM, though it will be appreciated that in some embodiments, the time threshold T can be adjusted each day or adjusted every other day, and the like. The time threshold T can be set, for example, right before peak solar irradiance to increase efficiency. For example, prior to the time threshold T, the ED system can run directly off solar power (curve B1 can align with curve A1). After the time threshold T, as shown in FIG. 2, the system can run at its most efficient operating point until the battery is fully charged, e.g., time t1, similar to Morning Fill strategy, at which point desalination power can increase sharply and can run along the desalination power curve (A1). While the Afternoon Fill strategy can produce more water than the Morning Fill strategy on some days, the time threshold T may not hold true every day. For example, cloud cover during the time threshold T may cause the Afternoon Fill strategy to desalinate at high power earlier or later in the day. However, after calibrating the time threshold T, the Afternoon Fill strategy can typically perform better than the Morning Fill strategy at least in cases in which solar irradiation is high during the time threshold T.

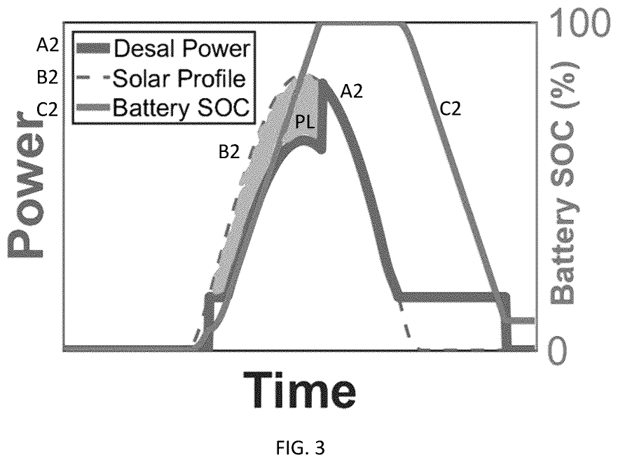

FIG. 3 illustrates another example embodiment of an EM strategy that can effectively offset the solar power profile by a power limit, ensuring a lower power operating point throughout the day for the ED system. This strategy, referred to as the “Charge Limit” strategy, can be a reactive EM strategy that can use, for example, the lifetime specifications of the battery manufacturer to prolong battery life by limiting the charging rate of the system. A person skilled in the art will recognize that the C rating of the battery is the charging rate of the battery and can measure the amount of current that the battery can charge or discharge. Most manufacturers can guarantee the lifetime of a battery at <0.2 C, which means inputting a current/power to fully charge the battery from empty in 5 hours or longer guarantees the lifetime of the battery. In practice, this means that if a 12 V battery with a 0.2 C lifetime rating has a capacity of 10 Ah, or a total energy capacity of 120 Wh, users should limit the input current to about 2 A or input power to about 24 W to ensure the lifetime of the battery. By determining the capacity of the battery used in the ED system and manufacturer battery lifetime data, the charge limit strategy can impose a charging power limit, otherwise referred to as charge power limit or power limit PL, for the battery, which is illustrated by the shaded offset between curves A2 and B2 in FIG. 3, as shown. It will be appreciated that some manufacturers guarantee the rated lifetime when using at <0.2, C but other manufacturers can guarantee their rated lifetime at a higher charge rate, e.g., 1 C.

Therefore, as more solar power is available (curve B2), increased power can be used for charging the battery until it hits the power limit PL. At that point, the system can charge the battery at the power limit PL to approximately maintain the charge power limit while performing desalination with the remaining available solar power until the battery is fully charged. It will be recognized that “approximately maintain the charge power limit” can signify that the battery is at the charge power limit and/or within 5% of the charge power limit. Moreover, it will also be appreciated that, in the case of the “Charge Limit” strategy, as well as “Morning Fill,” “Afternoon Fill,” as above, and “Top Fill,” as below, and any remaining strategies within this disclosure, the battery being “fully charged” can refer to the battery being charged to about 90% or more of its maximum possible charge, about 95% or more of its maximum possible charge, about 97% or more of its maximum possible charge, about 99% of its maximum possible charge, and/or 99.9% of its maximum possible charge. Once the battery is charged, the solar profile (curve B2) can be used for desalination (curve A2). This can continue until solar irradiance is insufficient to run desalination, at which point the battery can be used to complete desalination, as shown by the decline in curve C2. A person skilled in the art will recognize the circumstances that constitute the solar irradiance being insufficient for particular purposes. Primarily, when there is not enough solar irradiance to meet a minimum power threshold for powering the desalination system, e.g., when the solar irradiance does not provide sufficient enough power to operate the pumps and create any flow in a given system, power can be discharged from the battery to supplement the available solar irradiance to ensure the desalination system can have enough power to run at its minimum power threshold.

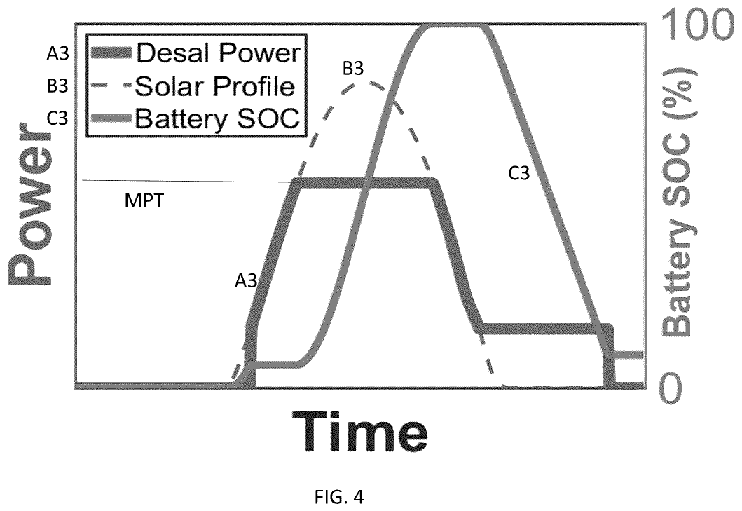

The three EM strategies described above (Morning Fill, Afternoon Fill, Charge Limit) are all non-predictive strategies that do not use forecasting of the solar irradiance to function. FIG. 4 illustrates another example embodiment of an EM strategy, on in which weather predictions can be used to regulate ED system efficiency. This strategy, referred to as the “Top Fill” strategy, can use weather forecasting to determine the most efficient power to run the ED system. Weather forecasting can be performed with a sensor, a weather station, models, and/or the like to gather data about expected weather conditions for the next day, for the next three days, for the next week, for the next month, and/or for the next year, etc. With foresight into the predicted solar irradiance profile, the Top Fill strategy can determine a maximum power threshold (MPT) above which all available solar power (curve B3) can be used to fully charge the battery (curve C3). Thus, the ED system can run using all available solar power (curve B3) when the solar power is less than the maximum power threshold MPT. When more solar power is available, the ED system can run at the power threshold MPT (curve A3), while any additional power can be used to charge the battery. In some embodiments, by the end of the day, the battery can be fully charged and begin discharging when solar irradiance is insufficient to run desalination, at which point the battery can be used to complete desalination, as shown by the decline in curve C3. That is, the Top Fill strategy can effectively flatten the solar irradiance profile so the system can avoid operating at higher power.

Use of one or more of the EM strategies disclosed herein can reduce ED system capital cost while producing the same amount of water as a similar system that does not incorporate an EM strategy. Overall, when compared to a PV-ED system that uses no batteries and time-variant operation, the Charge Limit strategy can produce the same amount of water daily while costing at least about 12.3% less in capital cost, while the Top Fill strategy can produce the same amount of water daily while costing at least about 16% less in capital cost. Further, another benefit of the presently disclosed EM strategies can include lower ED system desalination specific energy consumption (SEC). The battery and EM strategies of the present embodiments can reduce component sizes in the system like the ED stack and solar panels while producing the same amount of water at least because the EM strategy runs more energetically efficiently with a lower SEC. The Charge Limit strategy can have an average SEC of about 0.8898 kWh/m³ of water produced while the PV-ED system that runs directly off solar power has an average SEC of about 1.2055 kWh/m³ of water produced. These average SEC calculations can be taken from optimized ED system designs across a range of production volumes (e.g., approximately in a range of about 1 m³/day to about 100 m³/day) for a system that desalinated water from about 2000 mg/L to about 300 mg/L at about a 75% recovery ratio. In use, the Charge Limit strategy can have a lower capital cost than both the Afternoon Fill strategy and the Morning Fill strategy over the range of production volumes.

### Recirculation-Based Architecture

To accommodate the various-sized communities around the world lacking water, designers can use two architectures of ED systems for different size scales: batch and continuous. Batch architectures are more common for smaller-scale situations, often because it provides for lower capital costs and provides for more flexibility, while continuous architectures are more common for larger-scale situations, often because they can run continuously and can handle more throughput. Generally, the smaller scale systems with which batch architectures are used are approximately 2,500 gallons or less, while the larger scale systems with which continuous architectures are used are approximately 25,000 gallons or more. The general threshold for when batch should be used is when the ED system is producing approximately 4,000 gallons of water per day or less. This value was determined from multiple ED system design optimizations that maximize the daily water production volume of the system while minimizing the capital cost of the system across a range of design requirements. Similarly, ED systems can employ a continuous architecture when producing 17,000 gallons of water per day or more. A system between these two ranges can be either batch or continuous, with other tradeoffs between the technologies being case specific. For example, a continuous system or batch system may occupy different volumes of space, with a batch system using more valves and auxiliary components. These factors can be additional considerations beyond capital expenditure in this intermediary range. Thus, to ensure that PV-EDR systems can cost-effectively desalinate water for resource-constrained communities, PV-EDR systems will need to be sized properly for the community by selecting the appropriate architecture.

Batch systems rely on cycling water through the EDR system multiple times to remove the salt needed to produce water at the desired salinity. While recirculating water through the system is energetically inefficient due to pumping losses, batch systems are generally cheaper at small production volumes at least because they require fewer ED stacks and less capital. On the other hand, continuous systems pass water through the EDR system once and produce water at the desired salinity. Unlike batch, continuous is more energy efficient, but is more expensive in terms of initial capital cost at least because more membrane area is needed to remove the same amount of salt as a batch system. For off-grid systems, higher energy efficiency usually translates to small power systems, and therefore cheaper systems. For PV-EDR systems to help communities around the world, designers should also account for varying user requirements that will affect the system design, like the feed salinity and target salinity of the water, and the recovery ratio of the system. Salinity water sources can range in salinity around the world, while target salinity depends, for instance, on the preference for taste of the user(s). For EDR to be cost-effective, saline water that ranges approximately from about 1000 mg/L to about 4000 mg/L may only be considered in at least some instances.

Operating EDR systems using off-grid power can also be a challenge in balancing energetically efficient water production and cost. Most on-grid systems operate at the most energetically efficient operating point that will have the lowest specific energy consumption (SEC) for the system, and therefore produces the most amount of water using the least energy. Off-grid systems, however, have variable power available to the system throughout the day. Thus, operating at a constant single power can generally require a battery to store energy and expend energy throughout the day, which leads to higher costs. Instead, off-grid EDR systems can constantly change their power consumption to meet the varying power throughout the day to cost-effectively produce water. As a result, this may mean producing different quantities of water throughout the day, but less efficiently. By introducing a battery into the system, the water production of the system can be increased by storing energy during the day and allowing the system to run at its most efficient operating point during the night. However, batteries introduce additional costs and complexity to the system. With a variety of strategies to manage energy storage, each strategy has different implications on the cost of the overall system, which can make it unclear which strategy is best for cost-effective water production.

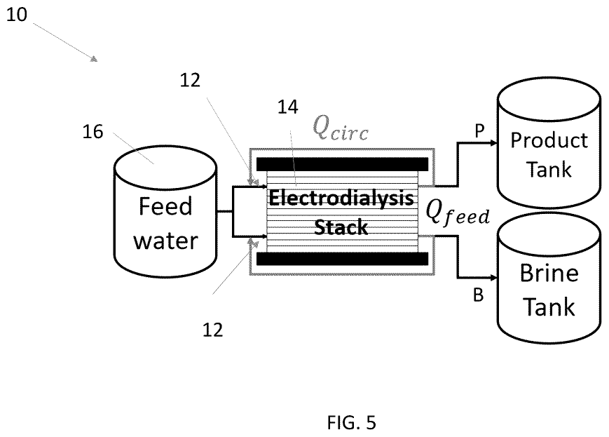

FIG. 5 illustrates an example embodiment of a recirculation-based architecture 10, referred to as hybrid architecture, which is capable of using time-variant operation to produce water at a desired salinity by recirculating some of its product water P and/or brine streams B to an inlet 12 of an ED stack 14. Similar to continuous systems, which produce water by passing it through the ED system once, hybrid architectures can operate nominally like a continuous system. For example, in continuous systems, when more power is available to the system, time-variant control can increase a flow rate and voltage in the system to use all the available power. As a result, the salt cut in the stack decreases, which can cause continuous systems to produce water at a higher salinity when more power is available. Hybrid architectures 10, however, can counter the reduced salt cut when more power is available by recirculating some of its water. Once more power is available and the product water salinity increases, some portion of the flow, Q_{circ}, can be recirculated to the inlet 12 of the ED stack 14. There, the feed water 16 can be mixed with the recirculated water to lower the total concentration of the water at the inlet of the stack, and thus the product water P concentration will also be lower. The flow rate of a hybrid EDR system, Q_{hyb}, can be defined as:

$${Q}_{hyb} = {Q}_{feed} + {Q}_{circ} \qquad ( 1 )$$

where Q_{feed} is the flow rate of the feed water into the system. Thus, the production volume of the hybrid system is Q_{feed}, or the amount of new water being introduced to the system.

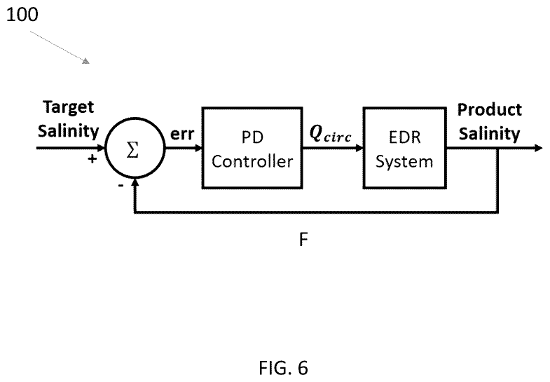

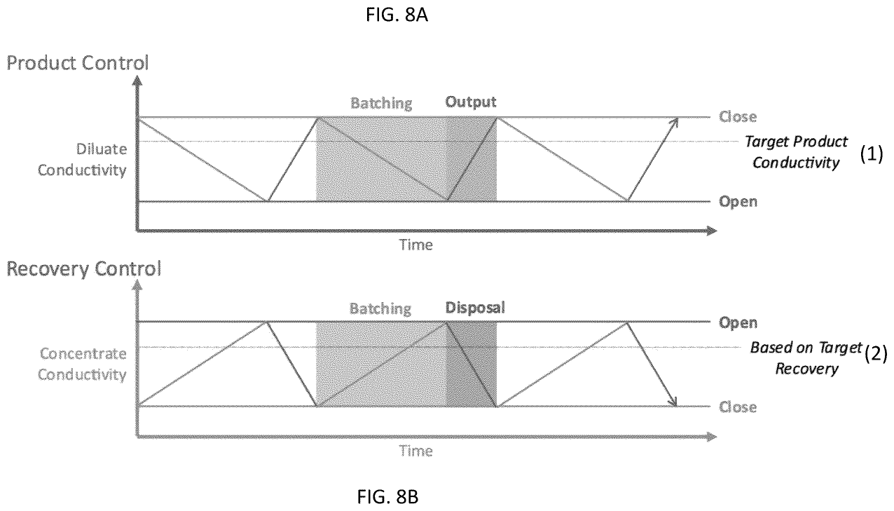

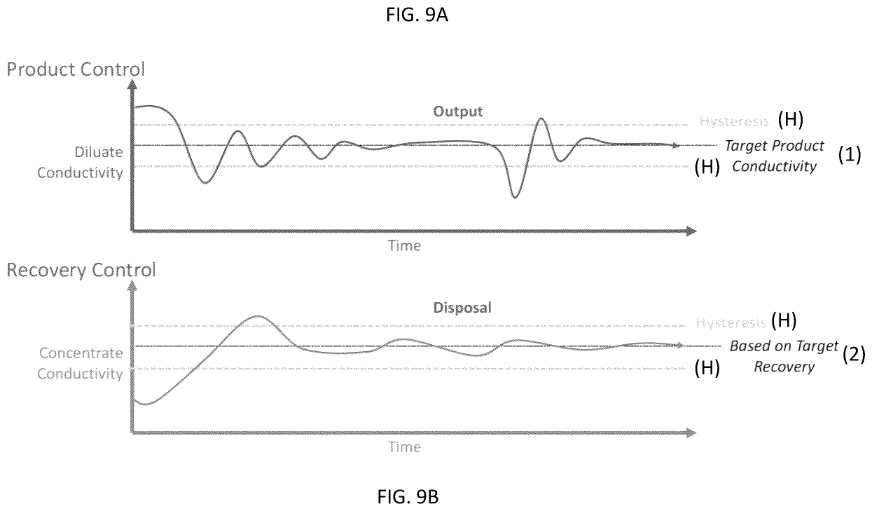

FIG. 6 illustrates an example embodiment of a controller 100 used to regulate the recirculated flow in the hybrid architecture 10 operation. To regulate the portion of the flow that is recirculated, a proportional-derivative (PD) controller 100 can be used, as shown, to recirculate and partially reuse processed water and feed water. For example, by taking the difference between the outlet concentration of the stack and the target concentration, the PD controller 100 can adjust the amount of flow F that is recirculated to bring the outlet concentration closer to the target concentration. Use of the controller 100 with various valves within the hybrid architectures of the present embodiments are discussed in more detail with respect to FIGS. 8A-8B and 9A-9B below.

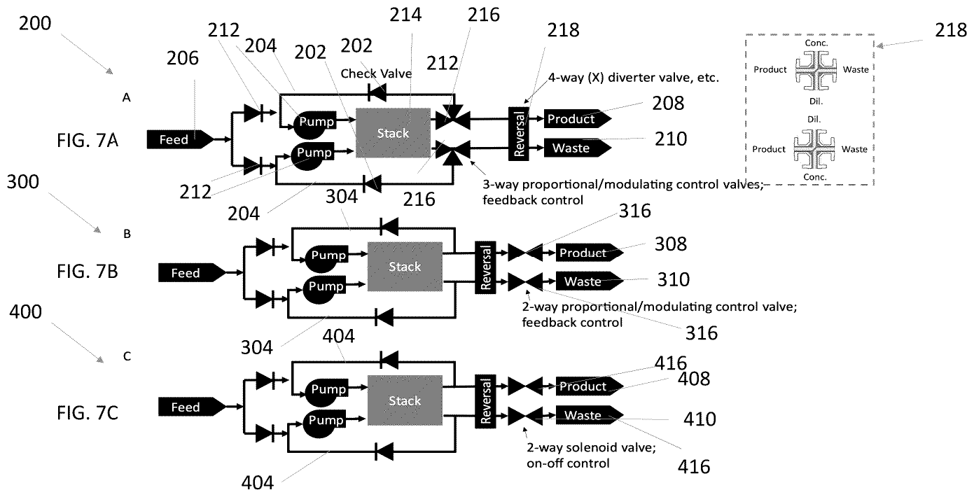

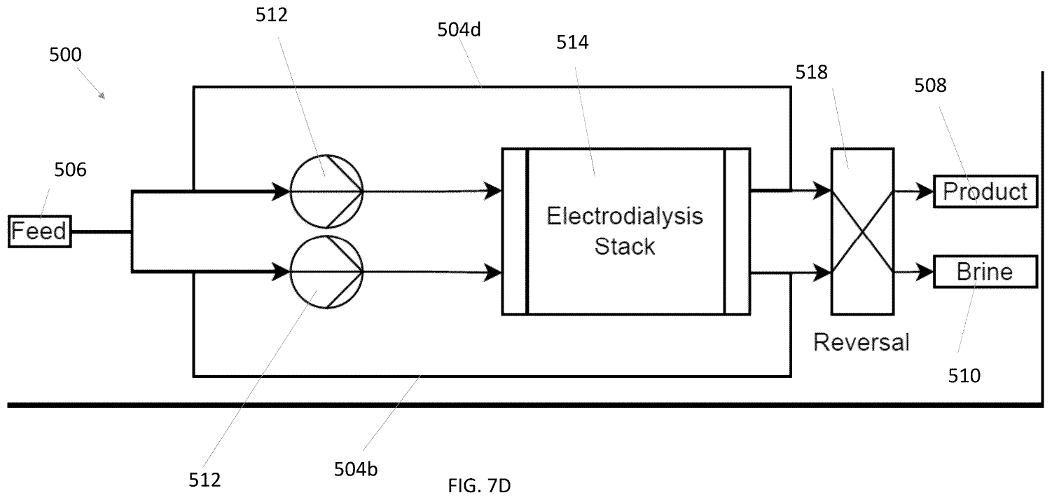

Hybrid architectures have not been integrated for a direct-drive control scheme, e.g., direct-drive desalination, nor for the aforementioned energy management schemes or commercial desalination systems. For example, common commercial desalination systems do not consider recirculating the diluate stream, and do not operate using variable-power tracking or energy management associated with renewables. FIGS. 7A-7C illustrate example embodiments of several novel architectures 200, 300, 400 that implement hybrid architectures for electrodialysis desalination, which have applicability and integrability to time-variant, power-tracking, and energy management control schemes. These architectures can implement load changing and implement the use of positive displacement pumps. Moreover, these architectures can reduce the cost of implementing hybrid architectures, which traditionally use multiport diverter and/or proportional/modulating control valves. Further still, these architectures can introduce functional simplicity, which can be important in resource-constrained settings in which these features may be deployed.

For example, FIG. 7A illustrates a hybrid architecture for electrodialysis desalination 200 that can include one or more check valves 202 to direct the water recirculating 204, the water fed into the system 206, and the water directed to product 208 and/or waste 210. These valves can be modulated, for example, by the controller 100 to regulate flows therethrough. Typical hybrid systems may use two pumps 212 per stream that is fed to the ED stack 214, one to control the feed to the stream 206 and another to control the recirculation of the stream 204. In some embodiments, the architecture 200 can use four check valves 202, two for the water fed into the system 206, and two for the recirculation of the stream 204, though these numbers can vary, e.g., be increased and/or decrease. In some embodiments, the architecture 200 can implement the check valves 202 to reduce the number of pumps used per stream. In some embodiments, the reversal valves 218 may be implemented as four (4)-way (X) configuration diverter valves, or as a series of solenoid valves, ball valves, and/or more. It will be appreciated that in the absence of check valves in the recirculation stream, backflow from product or waste streams back into the system may occur and/or feedwater may skip the stack and hydraulically short the system. In some embodiments, the flow may skip the pump only if the pump is operating sufficiently low, such that the feed pressure exceeds the suction or pump draw.

In some embodiments, positive displacement pumps can be used in lieu of check valves to enable the system to operate such that higher and low pressures are carefully controlled, along with such as with positive displacement cooperative valve operation. Some non-limiting examples of alternative pump choices can include nominal pumps, e.g., centrifugal, two-cavity vane pumps, and/or a variable displacement vane pump.

The methodology in which water can be redirected to recirculate or recycle in each stream can be commanded and controlled in numerous ways, as shown in FIGS. 7A-7C. Streams exiting the ED stack 214 can pass through one or more proportional or modulating control valves 216, which provide feedback control. FIG. 7A, for example, shows a three (3)-way, proportional, or modulating control valve 216, which can set itself to any proportion of outlet to recirculate flow. These modulating control valves 216 can provide three (3)-way feedback control for the recirculated stream 204, and the water directed to product 208 and/or waste 210 through a reversal valve 218. The same is regarded in the architecture 300 of FIG. 7B, where the two (2)-way proportional control valve 316 can function like a flow restrictor, making water tend to recirculate when closed. FIG. 7C shows a two (2)-way solenoid valve 416, which may be utilized in on-off control in a hybrid system 400.

FIG. 7D illustrates a hybrid architecture for electrodialysis desalination 500 featuring a feed and bleed approach. As shown, the feed and bleed approach has a feed 506 that splits into a pair of streams, with each stream being fed via a pump 512 to the ED stack 514. From the ED stack 514, the water can be recirculated via streams 504 to mix with the feed 506, while the remainder can flow through a reversal valve 518 to become product 508 and/or waste or brine 510, which operates similar to the embodiment discussed in FIG. 7A above. Note the reversal valves 518 can be used for directing the product stream 508 to a product outlet and/or brine stream 510 to a brine outlet, for example during electrical polarity reversal on the electrodialysis stack 514.

Recirculating water through the streams 504 can be accomplished in several ways, including one or more proportional control valve(s), solenoid valve(s), and/or secondary pump(s) on the recirculation streams. As shown, there can be two, independently recirculating streams 504, with a stream 504 on each of the diluate and brine sides. Recirculation of the outlet of the electrodialysis stack 514 on the diluate side 504d can dilute the feed 506 to an acceptable input to allow the stack to achieve the target product conductivity in a single pass, under the current operating conditions, which includes a flow rate and electrical current being applied to the electrodialysis stack 514. The control for the amount of diluate sent back in the stream 504d can be implemented as feedback control on product salinity, where if the diluate salinity leaving the ED stack 514 is greater than the desired product salinity, then more water can be recirculated 504. If the diluate salinity is less than the desired product salinity, then less water will be recirculated. Control of the diluate can be accomplished in several ways, including classical feedback control. The brine side recirculation in stream 504b can regulate the recovery ratio, and/or the amount of water produced over the total feedwater input. For example, recirculating more water in the brine stream 504b may result in a higher recovery ratio, and vice versa.

Each of FIGS. 7A-7D can be utilized in conjunction with direct-drive desalination. Where the pump speed and stack voltage can be controlled by a direct-drive controller, however, the recirculating streams 204, 304, 404 can be controlled using a number of feedback control mechanisms or methodologies, or other methodologies, to maintain: (1) a target salinity; and/or (2) a recovery rate. FIGS. 8A-8B illustrate an example of such control using solenoid valves as shown and discussed above with respect to FIGS. 7C and 7D. For example, in some embodiments, direct-drive desalination can be adapted to a feed and bleed system of FIG. 7D using solenoid valves at the outlets of the reversal valve 518 prior to the product and brine streams 508, 510 to provide feedback control of various components of the hybrid architecture. As shown in FIG. 8A, (1) the target salinity can be accomplished by controlling the valve associated with the product stream 208, 308, 408 with respect to a target product conductivity, and, as shown in FIG. 8B, (2) recovery control can be accomplished by controlling the valve associated with the brine stream 210, 310, 410 with respect to a target recovery. In (1), if the valve is more open, the product salinity will increase, as suggested by the upward-sloping portions of FIG. 8A, while conversely, if the valve is more closed, the salinity will decrease, as shown by the downward-sloping portions of FIG. 8A. Moreover, as shown, during batching, the valve is more closed to reduce salinity, while during output the valve is more open to produce an output having greater salinity. In (2), if the product valve is more closed, the recovery ratio (i.e., water efficiency) can increase, as less brine leaves the system, as suggested by the upward-sloping portions of FIG. 8B. If the valve is more open, the inverse can happen (i.e., decreased recovery ratio), as suggested by the downward-sloping portions of FIG. 8B. Moreover, as shown, during batching the valve is more closed to allow the system to recover, while during disposal the valve is more open to allow for disposal of brine.

FIGS. 9A-9B illustrate an example of corresponding control of product and recovery, except using proportional (e.g., 2-way or 3-way) control valves at the outlets of the reversal valve 218, 318 prior to the product and brine streams 208, 308, 210, 310. As shown, use of these valves can allow output and disposal, respectively, to oscillate more closely with respect to the target product conductivity and the target recovery values of FIGS. 9A-9B, respectively. For example, for product control as in FIG. 9A, diluate conductivity can be measured relative to time, with the conductivity oscillating around the target product conductivity substantially within the bounds of hysteresis values (H), with similar behavior observed for concentrate conductivity values over time in the recovery control of FIG. 9B. The target product conductivity may be at a setpoint such that the hysteresis value is generally below the acceptable product conductivity value. The recovery setpoint can be set based on the brine conductivity, and/or any combination of two flow rates sensed within the system (e.g., overall feed inlet, brine outlet, product outlet). Oscillations can be practically reduced with slower changes in flow rate and applied current to the electrodialysis stack.

In some embodiments, one or more architectures can be arranged in series to achieve a desired amount of desalination and/or efficiency. For example, the architectures of 200, 300, 400 can be arranged in series with one or more of another architecture 200, 300, 400 to increase efficiency of the ED system, as discussed above.

An exemplary benefit of hybrid architectures of the present embodiments over the existing batch and continuous architectures includes that hybrid architectures can be more cost-effective than batch at large production volumes. Hybrid architectures can produce water at a lower cost than batch ED systems when producing more than 80 m³ of water per day. At least because hybrid architectures recirculate water less frequently than batch systems, the energetic efficiency of hybrid systems can use smaller pumps and solar panels. Moreover, hybrid architectures can more reliably produce water at the desired target salinity for users than continuous systems when using variable power. At least because continuous systems can only pass water through the ED system once, using time-variant operation can cause the product water from the continuous system to be at a higher salinity than the desired target salinity. Time-variant operation can use higher flow rates and higher voltage to accommodate more power being available. In turn, this can cause the salt cut in the stack to decrease, which may cause the product salinity to increase when more power is available. Hybrid architectures can be capable of recirculating some of the product water back to the inlet to ensure that the product water is always at the target salinity.

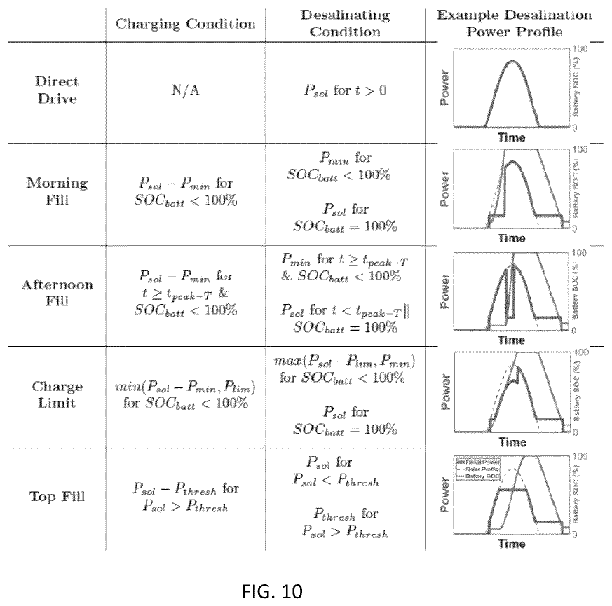

A summary of the charging and desalination conditions for each desalination strategy discussed above, along with a corresponding plot thereof, is shown for reference in FIG. 10. As shown, the charging conditions and the desalinating conditions for each of the EM strategies can be represented by equations, in which Pₘᵢₙ is the minimum power to desalinate, Pₛₒₗ is solar panel power, Pₗᵢₘ is charging power limit, Pₜₕᵣₑₛₕ is max power threshold, SOC_{batt} is state of charge of battery, and tₚₑₐₖ-τ is a time threshold. Tradeoffs between conditions can often depend heavily upon the demand profile of the consumers, as well as the risk tolerance and/or reliability requirements of the system owners. For example, a morning fill strategy may prioritize filling the battery in the beginning of the day, which may be advantageous for water demand profiles that have little activity in the morning, whereas an afternoon fill strategy may balance the prioritization of water production during the day. Moreover, a charge limit strategy can lead to greater battery lifetimes, while a top fill strategy may be the most efficient, but can be practically challenging to integrate.

Examples of the above-described embodiments can include the following:

1. A method of energy management for electrodialysis desalination, comprising:
determining a capacity of a battery in communication with an electrodialysis (ED) system such that energy from the battery is able to be used to perform desalination;
imposing a charge power limit onto the battery to limit the charging rate of the ED system such that the ED system operates at a lower power operating point than the capacity of the battery;
charging the battery using an available solar power until the battery reaches its charge power limit; and
charging the battery to approximately maintain the charge power limit while performing desalination with the remaining available solar power until the battery is fully charged.
   2. The method of example 1, further comprising using the available solar power for performing desalination after the battery is fully charged.
   3. The method of example 1 or example 2, wherein the available solar power for performing desalination substantially increases after the battery reaches its charge power limit.
   4. The method of any of examples 1 to 3, further comprising discharging the battery to perform desalination.
   5. The method of example 4, wherein discharging the battery occurs when the available solar power is insufficient to perform desalination.
   6. The method of any of examples 1 to 5, wherein charging the battery and performing desalination occurs substantially simultaneously prior to the battery reaching its charge power limit.
   7. The method of any of examples 1 to 5, wherein charging the battery occurs before starting to perform desalination.
   8. The method of any of examples 1 to 7, further comprising applying a time threshold at which the battery is configured to begin charging.
   9. The method of example 8, wherein the time threshold is set to a same time as a time threshold of a previous day.
   10. The method of example 8, wherein the time threshold is set to a time immediately before a peak solar irradiance.
   11. The method of any of examples 8 to 10, further comprising predicting the peak solar irradiance by measuring weather data.
   12. The method of any of examples 1 to 11, further comprising predicting the available solar power to determine time taken to charge the battery.
   13. A system architecture for electrodialysis desalination, comprising:
one or more pumps in fluid communication with an electrodialysis (ED) stack, the ED stack having an inlet for receiving one or more feed streams and an outlet for receiving one or more outlet streams;
a feed flowing a fluid to the ED stack via the one or more pumps;
a controller in communication with the one or more pumps and the ED stack, the controller being configured to operate under time-variant control to adjust one or more of a flow rate or a voltage to the ED stack to use power based on availability of the power; and
one or more valves disposed downstream of the ED stack to receive the one or more outlet streams, the one or more valves being configured to recirculate the one or more outlet streams to the one or more pumps.
   14. The system architecture of example 13, wherein an amount of fluid in the one or more outlet streams recirculated to the one or more pumps is based on at least one of a target concentration or a desired recovery rate of a product stream of the one or more outlet streams.
   15. The system architecture of example 14, wherein the amount of fluid in the one or more streams recirculated is calculated, using the controller, by taking the difference between an outlet concentration of the stack and a target concentration.
   16. The system architecture of any of examples 13 to 15, wherein the recirculated outlet stream of the one or more outlet streams mixes with the feed stream to lower the total concentration of the fluid at the inlet.
   17. The system architecture of any of examples 13 to 16, further comprising one or more check valves configured to direct the recirculated outlet stream of the one or more outlet streams to the one or more pumps.
   18. The system architecture of any of examples 13 to 17, wherein the one or more valves further comprises a modulating control valve.
   19. The system architecture of any of examples 13 to 18, further comprising one or more positive displacement pumps disposed along the one or more outlet streams to control a pressure of the recirculated stream of the one or more outlet streams.
   20. The system architecture of any of examples 13 to 19, wherein the controller is in communication with a battery that provides power to the ED stack.
   21. The system architecture of example 20, wherein the controller is configured to:
determine a capacity of the battery;
impose a charge power limit onto the battery to limit the charging rate thereof such that the ED stack operates at a lower power operating point than the capacity of the battery;
charge the battery using available solar power until the battery hits its charge power limit; and
charge the battery at the charge power limit while performing desalination with the remaining available solar power until the battery is fully charged.
   22. The system architecture of example 20, wherein the controller is configured to perform any of the methods of examples 1-12.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

One skilled in the art will appreciate further features and advantages of the disclosures based on the provided for descriptions and embodiments. Accordingly, the inventions are not to be limited by what has been particularly shown and described. To the extent the present disclosure includes illustrations and descriptions that include prototypes, bench models, or schematic illustrations of set-ups, a person skilled in the art will recognize how to rely upon the present disclosure to integrate the techniques, systems, devices, and methods provided for into a product and/or production method, such as commercially viable ED systems across a variety of small, medium, and/or large scales. All publications and references cited herein are expressly incorporated herein by reference in their entirety.

Some non-limiting claims that are supported by the contents of the present disclosure are provided below.

What is claimed is:

1. A method of energy management for electrodialysis desalination, comprising:
determining a capacity of a battery in communication with an electrodialysis (ED) system such that energy from the battery is able to be used to perform desalination;
imposing a charge power limit onto the battery to limit the charging rate of the ED system such that the ED system operates at a lower power operating point than the capacity of the battery;
charging the battery using an available solar power until the battery reaches its charge power limit; and
charging the battery to approximately maintain the charge power limit while performing desalination with the remaining available solar power until the battery is fully charged.

2. The method of claim 1, further comprising using the available solar power for performing desalination after the battery is fully charged.

3. The method of claim 2, wherein the available solar power for performing desalination substantially increases after the battery reaches its charge power limit.

4. The method of claim 1, further comprising discharging the battery to perform desalination.

5. The method of claim 4, wherein discharging the battery occurs when the available solar power is insufficient to perform desalination.

6. The method of claim 1, wherein charging the battery and performing desalination occurs substantially simultaneously prior to the battery reaching its charge power limit.

7. The method of claim 1, wherein charging the battery occurs before starting to perform desalination.

8. The method of claim 1, further comprising applying a time threshold at which the battery is configured to begin charging.

9. The method of claim 8, wherein the time threshold is set to a same time as a time threshold of a previous day.

10. The method of claim 8, wherein the time threshold is set to a time immediately before a peak solar irradiance.

11. The method of claim 8, further comprising predicting the peak solar irradiance by measuring weather data.

12. The method of claim 1, further comprising predicting the available solar power to determine time taken to charge the battery.

13. A system architecture for electrodialysis desalination, comprising:
one or more pumps in fluid communication with an electrodialysis (ED) stack, the ED stack having an inlet for receiving one or more feed streams and an outlet for receiving one or more outlet streams;
a feed flowing a fluid to the ED stack via the one or more pumps;
a controller in communication with the one or more pumps and the ED stack, the controller being configured to operate under time-variant control to adjust one or more of a flow rate or a voltage to the ED stack to use power based on availability of the power; and
one or more valves disposed downstream of the ED stack to receive the one or more outlet streams, the one or more valves being configured to recirculate the one or more outlet streams to the one or more pumps.

14. The system architecture of claim 13, wherein an amount of fluid in the one or more outlet streams recirculated to the one or more pumps is based on at least one of a target concentration or a desired recovery rate of a product stream of the one or more outlet streams.

15. The system architecture of claim 14, wherein the amount of fluid in the one or more streams recirculated is calculated, using the controller, by taking the difference between an outlet concentration of the stack and a target concentration.

16. The system architecture of claim 13, wherein the recirculated outlet stream of the one or more outlet streams mixes with the feed stream to lower the total concentration of the fluid at the inlet.

17. The system architecture of claim 13, further comprising one or more check valves configured to direct the recirculated outlet stream of the one or more outlet streams to the one or more pumps.

18. The system architecture of claim 13, further comprising one or more positive displacement pumps disposed along the one or more outlet streams to control a pressure of the recirculated stream of the one or more outlet streams.

19. The system architecture of claim 13, wherein the controller is in communication with a battery that provides power to the ED stack.

20. The system architecture of claim 19, wherein the controller is configured to:
determine a capacity of the battery;
impose a charge power limit onto the battery to limit the charging rate thereof such that the ED stack operates at a lower power operating point than the capacity of the battery;
charge the battery using available solar power until the battery hits its charge power limit; and
charge the battery at the charge power limit while performing desalination with the remaining available solar power until the battery is fully charged.
